(19) United States
(12) Patent Application Publication
(10) Pub. No.: US 2010/0036188 A1
(43) Pub. Date: Feb. 11, 2010

(54) MOLECULARLY IMPRINTED POLYMER, PROCESS FOR PRODUCTION THEREOF AND PROCESS FOR THE SELECTIVE TREATMENT OF POORLY DEGRADABLE AND/OR TOXIC COMPOUNDS IN LIQUIDS

(75) Inventors: Ute Steinfeld, St. Ingbert (DE); Barbara Palm, Kirkel-Limbach (DE)

Correspondence Address: BARNES & THORNBURG LLP, 11 SOUTH MERIDIAN, INDIANAPOLIS, IN, 46204, US

(73) Assignee: KIST-EUROPE FORSCHUNGSGESELLSCHAFT MBH, Saarbrucken (DE)

(21) Appl. No.: 12/278,717

(22) PCT Filed: Feb. 20, 2007
(86) PCT No.: PCT/EP07/01455

§ 371 Date: Sep. 9, 2008

(30) Foreign Application Priority Data
Feb. 20, 2006 (DE) 10 2006 007 796.2

(51) Int. Cl. A62D 3/176; A62D 3/30; A62D 3/38; A62D 3/19; A62D 3/17; C08J 9/00

(52) U.S. Cl. 588/309; 588/313; 588/320; 588/311; 588/306; 521/182; 521/183; 521/143

(57) ABSTRACT

A molecularly imprinted polymer and production process therefor and a process for selective treatment of poorly degradable and/or toxic compounds in liquids using the molecularly imprinted polymers. Such polymers and processes are required for selective removal and/or degradation of biological, poorly degradable pollutants or toxic compounds, for example from wastewaters. Consequently, a molecularly imprinted polymer suitable for the selective treatment of at least one poorly degradable and/or toxic compound is provided having a polymeric network which is made up of monomers and has cavities of predetermined size, wherein the cavities are arranged at predetermined spacings and have specific binding sites and/or patterns for the poorly degradable and/or toxic compounds.

The present invention relates to a molecularly imprinted polymer and also to a production method for this purpose and to a method for selective treatment of not easily degradable and/or toxic compounds in liquids using the molecularly imprinted polymers. Polymers and methods of this type are required in order selectively to remove and/or degrade not easily biodegradable harmful substances or toxic compounds, for example from sewage.

The conventional biological purification of sewage in sewage plants achieves merely insufficient degradation for a number of not easily biodegradable harmful substances or substances with a specific degree of persistence. For the purpose of a more extensive elimination of these materials from sewage or water, inter alia so-called “advanced oxidation” processes (AOP) are used in addition on a large industrial scale. These “advanced oxidation” processes use highly reactive radical species, mainly of the hydroxyl radical with a redox potential of +2.80 V as oxidant, in order effectively to remove not easily degradable harmful substances, in fact as far as possible to complete mineralisation of organic substances into carbon dioxide and water. Because of this high reactivity, the plurality of organic compounds in the water, i.e. also the easily degradable, are however attacked. This non-specific attack then leads, as a function of the type of “advanced oxidation” process which is used, to an unnecessarily high requirement for oxidants and/or energy in order to produce the reacting species. As a consequence thereof, an increase in costs for the technology can be observed and in addition the underlying process itself can lose its effectiveness.

It is therefore the object of the present invention to make available molecularly imprinted polymers and also a method for selective treatment of not easily degradable and/or toxic compounds in liquids, in which the selective treatment can be designed more specifically and hence also more economically.

This object is achieved by the molecularly imprinted polymer according to claim 1, the method for production thereof according to claim 3 and also the method for selective treatment of at least one not easily degradable and/or toxic compound in liquids according to claim 5. Advantageous developments of the polymers according to the invention, of the production methods according to the invention and also of the treatment method according to the invention are provided in the respective dependent claims. The method according to the invention for selective treatment of compounds has a plurality of individual steps which are intended to be explained subsequently in more detail. Firstly, the absorption of the compound, i.e. of a material or a specific material group from the liquid, such as for example water or sewage, into a molecularly imprinted polymer is effected, as described for example in claim 1.

The specific or selective absorption of the target molecule and similar compounds in the solution is effected, on the one hand, via the molecule configuration, on the other hand, by defined molecular recognition mechanisms or specific binding interactions (such as for example ionic interactions or salt bridges, hydrogen bridge bonds, hydrophobic interactions and others) with the binding groups at the cavity surfaces. The absorption of the relevant material or of the relevant material group can thereby be effected by means of adsorption (addition) on the surface just as by absorption (incorporation) in the interior of the material (in general, “sorption” or “sorbing” is therefore the terminology in the further course).

Also a combination or successive arrangement is conceivable of different selective polymer materials for each of the relevant not easily degradable substances which are present in the relevant sewage.

Subsequent to the absorption of the target compound in the polymer, foreign substances which are absorbed jointly in the polymer up to a certain proportion are washed out with suitable solvents or solvent mixtures. For application, there can hereby be as solvent water, all conceivable aqueous solutions and organic solvents, also in a mixture with each other and also with water or with dissolved organic or inorganic compounds. This step is not necessarily required but can possibly be implemented.

In a further step, the target compounds are released or desorbed as preferably absorbed compounds or the degradation products thereof with suitable solvents or solvent mixtures. Here also there can be used for application water, all conceivable aqueous solutions and organic solvents, also in mixtures with each other and with water or also with dissolved organic or inorganic compounds.

Subsequently, the method according to the invention, in which the target compounds are thus separated, can be combined or coupled also with different degradation processes, in particular so-called “advanced oxidation” processes (AOP=advanced oxidation processes). The respective harmful substances can be degraded with AOPs of this type.

A further improvement arises if materials or substances are used which act catalytically, i.e. accelerating the reaction. These can be used in addition or also for example coupled to the polymer. Coupling with the AOPs is likewise possible but also merely the activation energy for formation of specific oxidation products can be reduced. It is also possible to control the reaction by means of materials or substances of this type such that biodegradable products are formed even by partial oxidation and that hence the oxidant or oxidation method of the AOP can be used more effectively.

Furthermore, a combination with a biological disinfection is advantageous.

As indicated above already, the washing step for removing the jointly contained foreign substances and/or the release of the preferably absorbed material or material group (compound) can be circumvented or omitted. This is possible if the molecularly imprinted polymer (MIP) which is laden with the respective material is integrated directly in a subsequent AOP. The reagents required for the AOP can thereby be injected or conducted through directly into the polymer material. Even indirect coupling with catalysts is possible.

In this case, the compound to be treated selectively is degraded already directly in the polymer and then the degradation products are removed again or desorbed from the polymer with suitable solvents or solvent mixtures, as described above.

A further possibility or variant of the method resides in binding the catalytically active centre into the structure of the molecularly imprinted polymer (MIP) jointly and hence this serves as synthetic enzyme analogue.

The catalytic activity of polymers can arise as a result of correct organisation of the catalytic groups at the molecularly imprinted binding sites. Structures which produce hydroxyl radicals and/or other oxygen-containing oxidants can serve as catalytic groups.

In the case of a previously known established catalytic mechanism for the degradation of the relevant substances, it is possible to use transition state analogues (TSAs) in the production of the molecularly imprinted polymers, as a result of which the transition state of the relevant degradation reaction is stabilised and the product formation rate is increased and/or the product formation is controlled either directly or indirectly.

Typical degradation reactions can be for example: hydrolysis of esters, amides, ethers; ring cleavage, aromatic substitution and further reactions, the transition states of which can be used as transition state analogues in the production processes.

A further possibility is the use of coenzyme analogues or coordinating compounds for catalytic support of the reactions. Also other catalytic centres can be used.

The release of the degradation products is then effected after the degradation reaction, as mentioned above, with suitable solvents or solvent mixtures.

With the polymers according to the invention and the method according to the invention for selective treatment of compounds in liquids, a large number of advantages can be achieved relative to conventional methods.

On the one hand, simple and economical separation of harmful substances from easily degradable contents or matrix compounds which are disruptive during the treatment of water by means of AOP is possible. Also enrichment and concentration of the not easily degradable compounds or compound classes is possible in order, by means of reduction of the liquid volume, also to achieve a cost reduction in the AOP or even an increase in the degradation.

Furthermore, in the case of the method according to the invention, only the predetermined selected and relevant not easily degradable or toxic compounds or compound classes are absorbed specifically from the liquid, as a result of which an extension of the operating duration of the selective filter component (polymer) is made possible. The relevant harmful substances can thereby be degraded also subsequently or simultaneously, in contrast to use with activated charcoal, to form less toxic products, e.g. by means of an AOP which is integrated in the polymer or implemented subsequent to the separation by means of the polymer.

In particular, the method according to the invention enables flexible use of individually dimensionally tailored molecularly imprinted polymers for a large number of different critical harmful substances. The thus used molecularly imprinted polymers can be regenerated and re-used. It is also possible, instead of degradation of the not easily degradable compound, to recover these, in particular in the case of rare compounds, from the polymer. In total, there is consequently a large range of possible variations and adaptations of the liquid treatment system according to the present invention to the respective problem which is present.

The method can be applied for the treatment of liquid media, such as water or sewage, which is contaminated or laden with special harmful substances. There should be mentioned, in addition to further fields, as examples:

Industrial effluent, such as e.g. process effluent of the chemical or pharmaceutical industry or of the paper and pulp industry, municipal sewage, hospital sewage or treatment of partial flows thereof, and also rehabilitation of dangerous waste and waste dumps. The method is suitable for the treatment of sewage with a high AOX content.

The method can then be used for application in the sewage plant as a replacement for activated charcoal or the use of ultrafiltration as final purification.

Furthermore, the method can be applied for the treatment of harmful substance-loaded animal excretions, e.g. working animals. Recovery of rare chemicals which are absorbed in the selective filter component is also conceivable.

In the following, the method for the production of molecularly imprinted polymers (imprinting procedure of MIP) is now intended to be described briefly. This comprises inter alia
complex formation, which is effected via specific interactions, of the target molecule (template, print molecule) which is dissolved in a suitable solvent (porogen) or the molecular units or functional groups thereof with the so-called functional monomer (polymerisable unit which interacts with the print molecule),
followed by the polymerisation step together with the crosslinker (unit with two or more cross-linking possibilities with the functional monomers) for construction of a network of cavities of a defined size and specific binding sites and binding patterns at defined spacings,
and finally the washing out of the template molecule.

The subject of the present invention is the use in the context of liquid media in the environmental field, e.g. water or sewage, and with selective removal and also degradation of the contents of these liquid media. The selection and modification of the functional monomers or a mixture of functional monomers, of crosslinkers or a mixture of crosslinkers, of porogens or porogen mixtures and also of radical starters and suitable catalytic groups for specific target molecules or target molecule groups or the derivatives thereof and the production of a suitable washing and purification protocol for newly produced polymers is thereby of relevance. The invention relates, in addition to the production of novel functional monomers, also to the method according to the invention for selective treatment of liquids with an absorption, washing, desorption and degradation step with the respectively used materials and reagents or technologies, if required the method can contain all the mentioned steps or only selected ones.

Typical functional monomers which are used (polymerisable unit which interacts with the print molecule) can be:

carboxylic acids, such as acrylic acid, methacrylic acid, trifluoromethacrylic acid, vinylbenzoic acid, itaconic acid, and also the amides thereof;
sulphonic acids such as acrylamidomethylpropanesulphonic acid;
heteroaromatic or weak bases, such as substituted or unsubstituted vinylpyridines, vinylpyrimidines, vinylpyrazoles, vinylimidazoles, vinyltriazines, vinylpurines, -indoles, -quinolines, -acridines, -phenanthridines, bis(acrylamido)pyridine;
aliphatic or aromatic vinyl derivatives, such as substituted or unsubstituted styrenes, vinyl naphthalenes, vinyl naphthalene carboxylic acids, vinyl naphthols, vinyl anthracenes, vinyl anthracene carboxylic acids, vinyl phenanthrenes, vinyl phenanthrene carboxylic acids and similar condensed aromatics, vinyl benzamidine; acryloylamino-benzamidine, (amidinoalkyl)-styrene, the alkyl being able to be methyl, ethyl or propyl, N-acryloyl-(amidinoalkyl)-aniline, vinyl derivatives with chelate-forming groups, such as iminodiacetic acid, ethylenediaminetetraacetic acid and the like, for complexing metal ions, silanes and also mixtures of monomers of this type. Other functional monomers can also be used.

There can serve as crosslinkers (unit with two or more cross-linking possibilities with the functional monomers):

isomers of divinylbenzene;
bis(acryloyl)-alkanes, ethane, propane and butane being possible as alkanes;
systems based on acrylic acid or methacrylic acid, such as e.g. ethyleneglycoldimethacrylate (EDMA) and trimethylolpropanetrimethacrylate (TRIM);
tri- and tetrafunctional acrylate crosslinkers, such as e.g. pentaerythritoltriacrylate (PETRA) and pentaerythritoltetraacrylate (PETEA) and also
crosslinkers which contain functional groups, such as e.g. acrylamide units which are cross-linked to each other on the amide nitrogens via aliphatic (methylene- and the like), aromatic (phenylene- and the like) or heteroaromatic (pyridinyl- and the like) spacers. Also other crosslinkers can be used, for example also crosslinkers which are stable relative to UV light or ozone.

There can be used as porogens (solvents which serve as solvents for the polymerisation reaction and induce porosity in the imprinted polymer) solvents of a different dielectric constant which influence parameters, such as different swelling properties of the polymer, different morphology of the polymer with various structures and pore diameters/porosity or different binding strengths of the non-covalent interactions, in particular aliphatic or alicyclic hydrocarbons, such as hexane, heptane or cyclohexane;

aromatic hydrocarbons, such as toluene;
halogenated hydrocarbons, such as chloroform, dichloromethane or 1,2-dichloroethane;
short-chain alcohols, such as methanol, ethanol, propanol;
ether, acetonitrile, tetrahydrofuran, ethylacetate, acetone, dimethylformamide, dioxane, dimethylsulphoxide;
also in mixtures with each other and with water.

There can be used as initiators (radical starters) 2,2′-azobis-isobutyronitrile (AIBN), 2,2′-azobis-(2,4-dimethylvaleronitrile) (ADVN) and others, the use of UV light is also possible.

The molecularly imprinted polymers can be present, according to the production process, in the following forms:
production of polymer monoliths and subsequent fragmentation,
a grafting of the imprinted polymer on preformed particles,
production of polymer balls from suspension-, emulsion- or dispersion polymerisation,
polymer particles which are bonded on thin films or polymer membranes,
polymer membranes,
surface-imprinted polymer phases: the formed complexes of the template molecules with the functional monomers bind to activated surfaces, such as e.g. silicon or glass surfaces, and produce defined imprinted structures after washing out.

The polymer can be introduced into a separating column or into a filter device, made of plastic material, glass, stainless steel or other materials; or be bonded on thin films, surfaces of different materials or polymer membranes or even be used itself as membrane. Alternatively, the particles can be used floating freely in the liquid phase. Also other devices can be used for absorbing the polymer.

Also a combination or successive arrangement of a plurality of sorption steps with the same or different selective polymer materials is conceivable. The reactor shape can also vary.

The current of the water laden with the relevant material or the relevant material group can thus be conducted both through the separating column, filter device, membrane etc. and be conducted almost parallel past the sorbing material. Also other methods can be used.

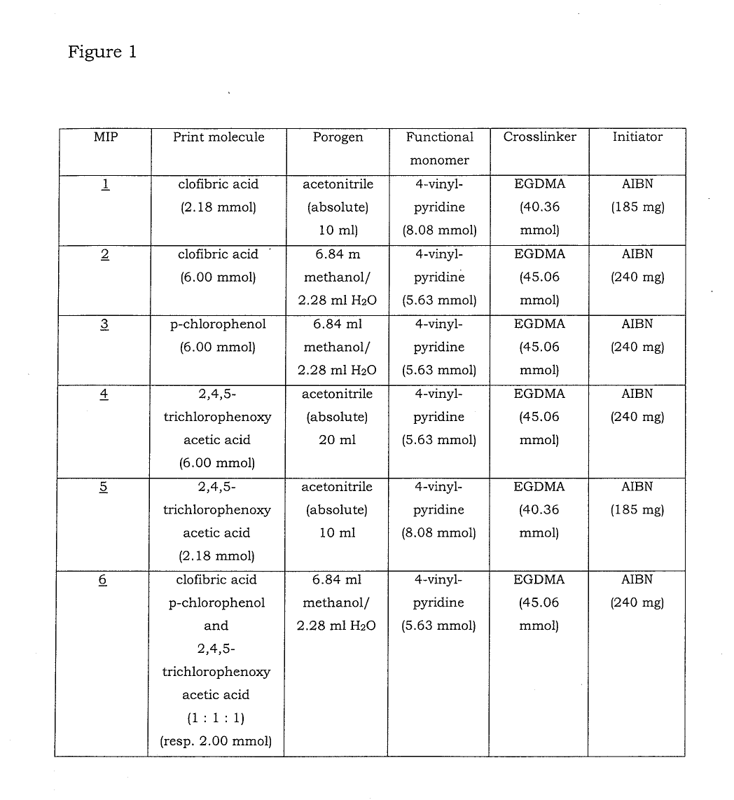

A few examples of polymers which are imprinted with molecules of the chlorophenoxy compound group are represented subsequently. These are presented in the table in FIG. 1. This table thereby represents the relevant substances used respectively for the production of the molecularly imprinted polymers.

The individual components were mixed together with ice cooling in 50 ml test tubes, rinsed for 5 min. with nitrogen, sealed with parafilm and left for 19 h at 60° C.

The polymer blocks were comminuted for processing until particles with a particle size <250 μm were produced, thereafter they were crushed four times with respectively 50 ml acetone and filtered respectively via a 20 μm sieve.

The purification of the polymers was effected:

in the case of polymer 1 and 5:
respectively four times with acetonitrile:acetic acid (99:1) and methanol:acetic acid (90:10) at 65° C., thereafter washed five times with respectively 50 ml water,
   in the case of polymer 4:
respectively twice with respectively:
50 ml acetic acid (glacial acetic), 50 ml acetonitrile:acetic acid (1:1), 50 ml acetonitrile:acetic acid (90:10), 50 ml methanol:acetic acid (80:20), 50 ml methanol and washed five times with respectively 50 ml water.

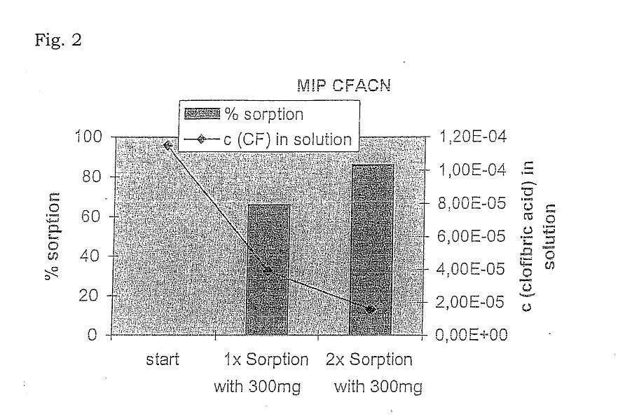

FIG. 2 now shows the proportion of sorbed (in %) and concentration of the clofibric acid remaining in the aqueous phase (in mol/l) after one or two sorptions on respectively 300 mg of the molecularly imprinted polymer in the MIP 1. As sewage to be treated there were used hereby 10 ml landfill leachate with the addition of 1.2*10⁻⁴M clofibric acid. To this sewage to be treated there were added 300 mg MIP 1 and agitation for 30 minutes was implemented.

It can be detected immediately that, even with a single sorption, over 60% of the clofibric acid was removed from the sewage. With twofold sorption, a sorption rate of over 80% is achieved.

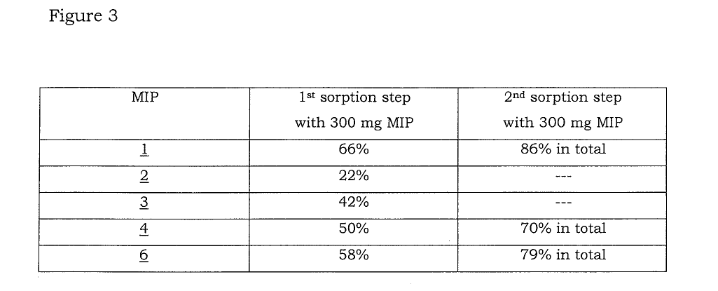

FIG. 3 shows, in table form, the proportion (in %) of the sorbed clofibric acid (initial concentration c=1.2*10⁻⁴M in landfill leachate) after single (column 2) or twofold sorption (column 3) with respectively 300 mg molecularly imprinted polymer after incubation over 30 minutes with agitation. Column 2 thereby represents the molecularly imprinted polymer used according to the table shown in FIG. 1.

It can also be detected here again that excellent sorption rates are achieved by means of the molecularly imprinted polymers according to the invention.

1. A molecularly imprinted polymer for selective treatment of at least one of a not easily degradable compound and a toxic compound with a polymer network constructed from monomers, with cavities of a predetermined size, the cavities being disposed at predetermined spacings and having at least one of specific binding sites and specific binding patterns for the compounds.

2. The polymer according to claim 1
wherein the monomers comprise at least one of carboxylic acids, the amides thereof of carboxylic acids;
sulphonic acids;
heteroaromatic bases, weak bases;
aliphatic vinyl derivatives, aromatic vinyl derivatives,
isomers of divinylbenzene, bis(acryloyl)-alkanes,
systems based on acrylic acid, systems based on methacrylic acid;
trifunctional acrylate crosslinkers, tetrafunctional acrylate crosslinkers, and crosslinkers which contain functional groups which are cross-linked to each other on amide nitrogens via at least one of aliphatic spacers, aromatic spacers and heteroaromatic spacers.

3. A method for production of a molecularly imprinted polymer for selective treatment of at least one of a not easily degradable compound and a toxic compound with a polymer network constructed from monomers, with cavities of a predetermined size, the cavities being disposed at predetermined spacings and having at least one of specific binding sites and specific binding patterns for the compounds,
the method comprising forming a complex of said monomers with at least one of said compounds, molecule parts thereof and structural analogs thereof in a solvent,
polymerizing the complex with a crosslinker to form a polymer network with cavities having at least one of a defined size, binding sites and predetermined patterns which are specific for the compound, and
washing out the compound.

4. The method according to claim 3
wherein forming a complex of said monomers with at least one of said compounds, molecule parts thereof and structural analogs thereof comprises forming a complex of at least one of carboxylic acids, the amides thereof;
sulphonic acids;
heteroaromatic bases, weak bases;
aliphatic vinyl derivatives, aromatic vinyl derivatives,
systems based on acrylic acid, systems based on methacrylic acid;
trifunctional acrylate crosslinkers, tetrafunctional acrylate crosslinkers, crosslinkers which contain functional groups which are cross-linked to each other on amide nitrogens via at least one of aliphatic spacers, aromatic spacers and heteroaromatic spacers, solvents which influence parameters;
aromatic hydrocarbons;
halogenated hydrocarbons;
short-chain alcohols;
ether, acetonitrile, tetrahydrofuran, ethylacetate, acetone, dimethylformamide, dioxane, dimethylsulphoxide; mixtures of these and mixtures of these with water.

5. A method for selective treatment of at least one of a not easily degradable compound in liquids and a toxic compound in liquids,
the method including contacting the liquid with at least one polymer which is molecularly imprinted to at least one of the compound to be treated and one of the degradation products thereof,
and absorbing the at least one of the compound to be treated and the degradation product thereof in the molecularly imprinted polymer.

6. The method according to claim 5 further including coupling the molecularly imprinted polymer to a catalyst material which accelerates the degradation of the material to be treated.

7. The method according claim 5 further including coupling the molecularly imprinted polymer to a catalyst selected from coenzyme analogs and coordinating compounds.

8. The method according to claim 5 further comprising effecting the degradation by at least one of advanced oxidation processes (AOP), plasma treatment, photocatalysis, ozonization, ultraviolet irradiation, and Fenton processes.

9. The method according to claim 5 further including introducing at least one of titanium, iridium oxide, iron and diamond into the polymers.

10. The method according to claim 8 further including introducing radical formers in dissolved form and rinsing the radical formers around the molecularly imprinted polymers.

11. The method according to claim 5 including using at least two different molecularly imprinted polymers to treat at least two compounds which are at least one of not easily degradable and toxic.

12-15. (canceled)

16. The method of claim 5 further including removing at least one compound which is not to be treated from the molecularly imprinted polymer and subsequently removing the at least one of the compound to be treated and the degradation product of the compound to be treated from the molecularly imprinted polymer.

17. A method for at least one of treatment, purification and quality improvement of at least one of industrial effluents, process effluents of the chemical industry, process effluents of the pharmaceutical industry, process effluents of the paper and pulp industry, municipal sewage, hospital sewage, and effluents of animal husbandry operations, the method comprising contacting the at least one of industrial effluents, process effluents of the chemical industry, process effluents of the pharmaceutical industry, process effluents of the paper and pulp industry, municipal sewage, hospital sewage, and effluents of animal husbandry operations with at least one polymer which is molecularly imprinted to at least one of a compound contained in the at least one of industrial effluents, process effluents of the chemical industry, process effluents of the pharmaceutical industry, process effluents of the paper and pulp industry, municipal sewage, hospital sewage, and effluents of animal husbandry operations which compound is to be treated and one of the degradation products thereof, and absorbing the at least one of the compound to be treated and the degradation product thereof in the molecularly imprinted polymer.

18. A method for the recovery of at least one of a rare chemical and a degradation product thereof, the method comprising contacting the at least one of a rare chemical and a degradation product thereof with at least one polymer which is molecularly imprinted to the at least one of a rare chemical and a degradation product thereof, and absorbing the at least one of a rare chemical and a degradation product thereof in the molecularly imprinted polymer.

19. A method for at least one of rehabilitation of dangerous waste, dewatering of waste dumps and rehabilitation of waste dumps, the method comprising contacting the at least one of dangerous waste and a waste dump with at least one polymer which is molecularly imprinted to the at least one of a chemical contained in dangerous waste and a waste dump and a degradation product of the at least one of a chemical, and absorbing the at least one of a chemical and a degradation product thereof in the molecularly imprinted polymer.
